(19) United States
(12) Patent Application Publication
(10) Pub. No.: US 2014/0359517 A1
(43) Pub. Date: Dec. 4, 2014

(54) Turning a Page on a Display

(71) Applicant: Blikiling Enterprises LLC, Wilmington, DE (US)

(72) Inventors: Michel Elings, Nieuwegein (NL); Thijs Zoon, Utrecht (NL)

(73) Assignee: Blikiling Enterprises LLC, Wilmington, DE (US)

(21) Appl. No.: 14/291,881

(22) Filed: May 30, 2014

Related U.S. Application Data
(60) Provisional application No. 61/829,166, filed on May 30, 2013.

(51) Int. Cl. G06F 3/0483; G06F 3/0485; G06T 13/00; G06F 3/0488

(52) U.S. Cl. CPC G06F 3/0483; G06F 3/0488; G06F 3/0485; G06T 13/00
USPC 715/776

(57) ABSTRACT

Some embodiments provide a method for displaying an electronic publication. The method receives a selection of a cover page displayed for an electronic publication. The method animates an opening of the cover page to a first content page of the electronic publication that appears as an opposite side of the cover page during the opening animation. While displaying a second content page of the electronic publication, the method receives input to close the electronic publication. The method animates a closing of the electronic publication in order to display the cover page. The second content page appears as an opposite side of the cover page during the closing animation.

### FIELD OF INVENTION

This disclosure relates to changing the displayed content in a digital publication.

### BACKGROUND

Much of the content that used to be available only as hard copies is now available digitally or as electronic documents. Publications, such as journals, books, newspapers and magazines are rapidly migrating to digital media, and user devices are evolving to better accommodate this new way of viewing and reading content. For example, touchscreen displays and expanded storage capability have opened the door to many new ways in which users can interact with displayed content.

Digital publications have not simply replaced the old journal articles and newspaper articles whose main purpose is to provide information. Digital publications are also replacing publications whose function it is to also provide entertainment and pleasure, such as magazines. Unlike a scientific or medical journal article which are usually read purely for information, magazines and publications that partly provide entertainment/pleasure usually want to have a personality beyond straightforward information. In a paper magazine, the quality of paper, types of images, and scents from enclosed perfume samples could be used to enhance user experience, in addition to the quality of articles. These peripheral factors turn the experience of reading a magazine into more than a straightforward obtaining of information. With digital media, however, some of these user experience enhancement techniques, such as paper quality, are no longer available. Hence, publishers and developers are challenged to come up with novel ways of differentiating one publication from others and enhancing the experience a user derives from reading a digital publication.

While the migration to digital media took away some methods of user experience enhancement, it also opens new possibilities. Specifically, no longer being restricted to the limitations and properties of paper and printing provides many new degrees of freedom.

### BRIEF SUMMARY

Some embodiments provide a method to allow the contents of a digital publication to be presented in a way similar to a physical paper publication, but without the physical limitations of such a physical publication. Specifically, some embodiments provide features that allow the user (i.e., the reader) of an electronic publication to “turn a page” in an electronic document in a way that visually simulates the turning of a physical page without the limitations of physical printing, in which the opposite side of a particular page is limited to always being the same page.

In some embodiments, the electronic device implementing the method displays a first image (e.g., a page) of a digital publication, receives a triggering input from a user, and determines the nature of a second image (e.g., page) based on the triggering input and the currently displayed first image. The electronic device displays the rotation of the first image in response to the triggering input (e.g., to simulate the physical turning of a page of the publication), resulting in the display of the second image upon completion of the rotation.

More specifically, in some embodiments the first image is a cover page of a digital publication, such as a magazine issue, (which may be displayed in a layout among several other cover pages of other digital publications). The user can select the cover page, causing the electronic device to animate the opening of the cover page to a first content page of the electronic publication. During the animation, the first content page appears as the opposite side of the cover page. The user can then navigate through the electronic publication (e.g., by scrolling through pages) to a second content page. From the second content page, the user provides input to close the electronic publication, and the application animates a closing of the electronic publication in order to display the cover page again. During this animation, the second content page now appears as an opposite side of the cover page. That is, irrespective of which content page is currently displayed for the electronic publication, the user can always turn that page directly to the cover page to close the publication. In addition, when the user returns to the electronic publication (e.g., by again selecting the cover page), in some embodiments the second content page will appear as the opposite page of the cover page, enabling the user to continue reading where he previously left off.

In some embodiments, the electronic device for viewing the electronic publications is a touchscreen device and the user inputs are touch input. For instance, in some embodiments a user provides a tap input on the cover page in order to select an electronic publication to read, then provides scrolling input to navigate through the electronic publication. To return to the cover page and close the electronic publication, in some embodiments the user can provide a pinch gesture over the location of the displayed content page. In addition, some embodiments enable the user to close the electronic publication by scrolling past the last page of the publication, at which point the electronic device animates the closing of the electronic publication with the last content page appearing as the opposite page of the cover page.

### BRIEF DESCRIPTION OF THE DRAWINGS

The novel features of the invention are set forth in the appended claims. However, for purposes of explanation, several embodiments of the invention are set forth in the following figures.

FIG. 1 depicts a display shown on a display device.

FIG. 2 depicts the display on a selection page presenting a plurality of publications from which a user can choose.

FIG. 3 illustrates an example where the user tapped on a publication.

FIG. 4 depicts what is shown after the cover page rotates 180°, or flips open to reveal the “opposite page”.

FIG. 5 depicts how a user can “close” the publication without reaching the last page.

FIG. 6 depicts the situation where the user scrolled through all the content pages of a publication by continually swiping/sliding his finger in the first direction.

FIG. 7 is a flowchart depicting a method of changing a displayed content in accordance with an embodiment of the inventive concept.

FIG. 8 is a block diagram illustrating an example display device that may be used to implement the inventive concept of some embodiments.

### DETAILED DESCRIPTION

The inventive concept disclosed herein enhances user experience with digital publications by allowing the contents of a digital publication to be presented in a way similar to a physical, paper publication but without being limited by the physical limitations of a paper. More specifically, the disclosure presents features that allow a reader of an electronic publications to “turn a page” in an electronic document in a way that visually simulates a real turning of a page but without being limited to what is physically printed on the opposite side of the paper. Although the inventive concept is disclosed herein in the context of a touchscreen embodiment, this is not a limitation of the inventive concept, which may be adapted to be used with other modes of user interface.

In one aspect, the inventive concept allows a user to select a magazine issue to read based on a “cover page,” open the cover page to view the content, and close the publication from anywhere in the magazine to return to the cover page. Regardless of where in the publication the user is—the beginning, middle, or the end—the user can always “turn the page” to find the cover page when he is ready to stop reading.

In another aspect, the inventive concept pertains to a computer-implemented method of dynamically determining the content of a next page that will be shown depending on user input and what is being displayed when the user input was received.

In yet another aspect, the inventive concept pertains to a computer-implemented method that includes displaying a first image of a digital publication, receiving a triggering input from a user, determining what a second image should be based on the triggering input and what is currently displayed, rotating the first page to simulate physical turning of a page in response to a triggering input, and replacing the first page with a second image upon completion of the rotating.

In another aspect, the inventive concept pertains to a computer-readable storage medium having stored therein instructions which, when executed, causes a device to perform the above steps. In another aspect, the inventive concept pertains to a device that stores instructions to perform the above steps.

In one embodiment, the first image is a cover page of a digital magazine and the second image is an inside page. When a user selects a cover page, the cover page rotates to reveal the inside page. The inside page may be followed by one or more content pages. The content pages may be separated by a line between adjacent pages. The content pages may be translated in a first direction or a second direction opposite the first direction (allowing the user to scroll back and forth through the inside pages) depending on the type of input that is received.

In another embodiment, the first image is a last content page and the second image is the cover page. Upon reaching a last one of the content pages, further attempt to scroll by the user would automatically collapse the passed pages behind the last content page and rotate the last content page to simulate a physical turning of the last page. When the last page turns, the cover page is displayed again. In a physical world, the cover page can only have one image on the other side of the paper. With the inventive concept disclosed herein, any page can be the page that is on the other side of the cover page. The content that is on the other side of the cover page is dynamically adjusted depending on the user action and the content that was being displayed when the user action was received.

A user may decide to “close” the digital publication (e.g., a digital magazine) without reaching the last one of the inside pages. In one embodiment, the user may place one finger on one content page and another finger on another content page and move them toward each other (e.g., pinch). Upon receiving this user input, the first content page and the second content page become stacked. For example, the two pages may be rotated in opposite directions toward each other, simulating two pages “meet” at the line that separated them. In another example, the two pages may slide behind a third content page. After the stacking is complete, only one image (the first image) is displayed. The first image rotates to display the cover page (the second page).

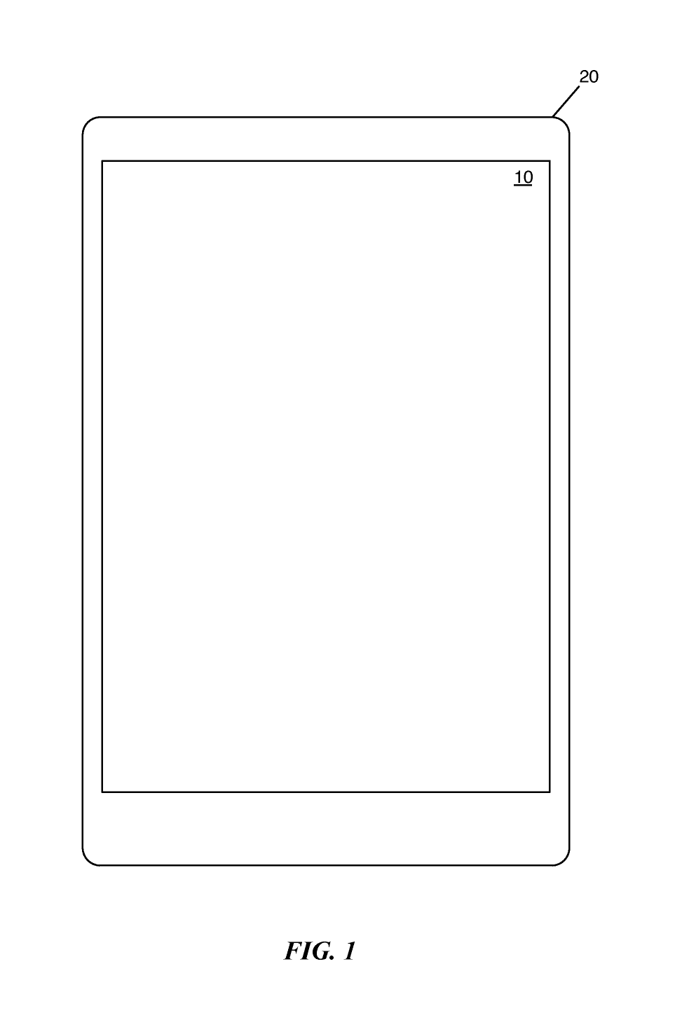

FIG. 1 depicts a display 10 shown on a display device 20. The display 10 may be any form of visual user interface, such as a monitor, a display (e.g., LCD, OLED), a touchscreen, etc. The display device 20 also includes audio communication components such as a microphone 30 and a speaker 32. The display 10 may also display any information that user requested, such as articles or pictures. A digital publisher may create content and upload it for a user to access, e.g. via an application. Third parties can also buy advertising options. A digital publication may be any type of publically available information including but not limited to magazines, catalogues, books, newspapers, and newsletters.

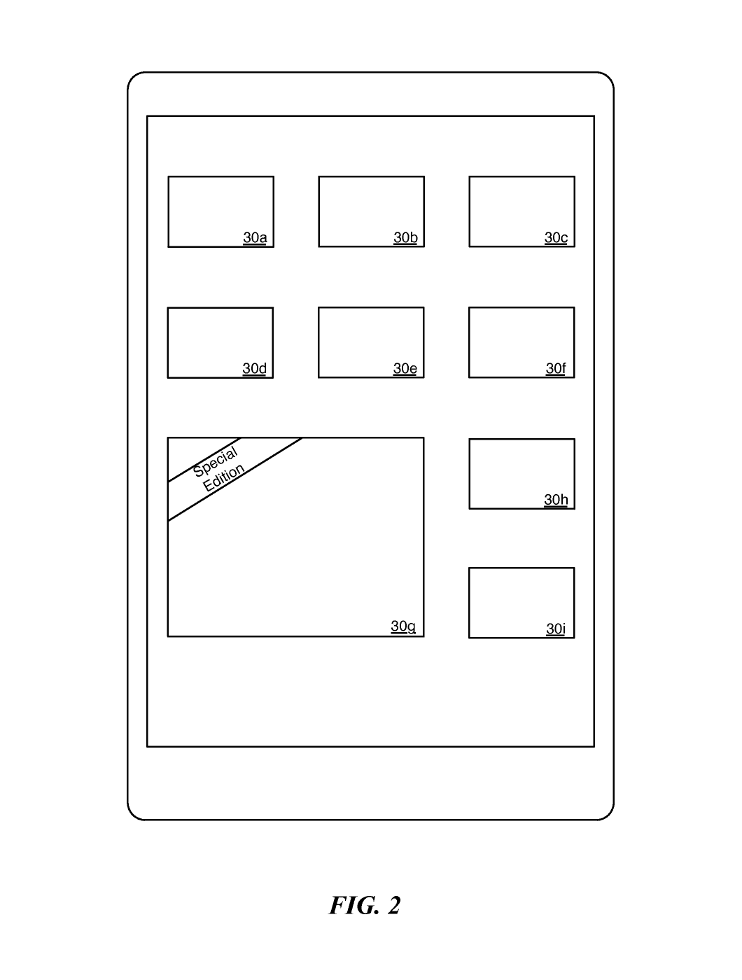

FIG. 2 depicts the display 10 on a selection page presenting a plurality of publications 30a through 30i (collectively publications 30) from which a user can choose. The “i” in the reference numeral 30i is not intended to be a specific number, as the exact number of publications available is not a limitation of this disclosure. In one embodiment, each of the publications 30 is an issue of a magazine or a book with a specific theme or topic. Each of the rectangle that is shown in FIG. 2 is a “cover” of the respective publication and provides images and/or words indicating the representative content of each publication 30. Hence, the selection page is similar a newspaper stand or a magazine stand. A user can look through the selections by scrolling through the selection page and looking at the covers of the available publications 30.

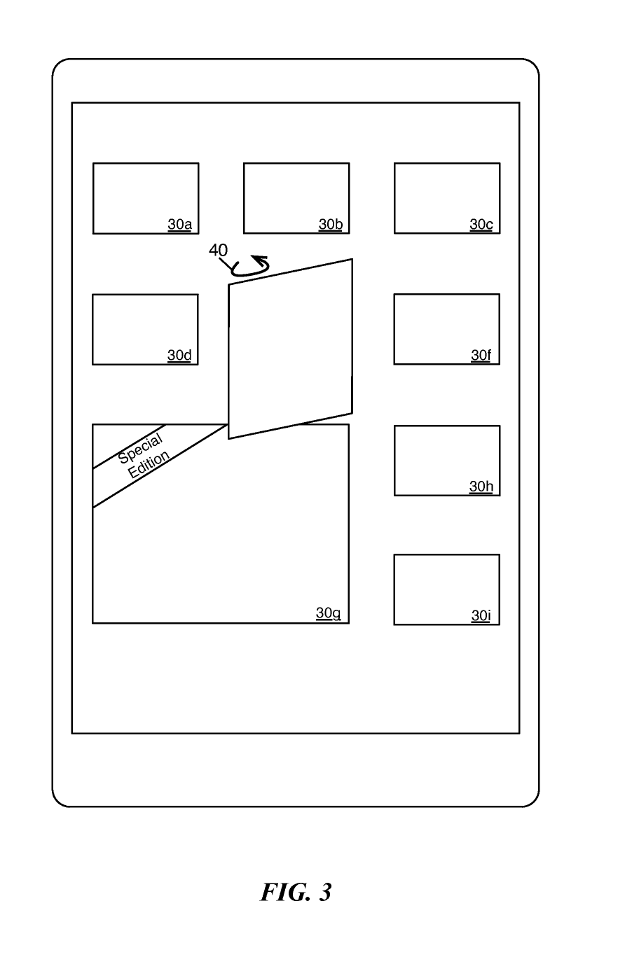

When the user chooses a publication, he can digitally “open” the publication. This “opening” of the publication may be done using any appropriate touch, swipe, or gesture with a hand or a tool. In one embodiment where the display 10 is a touchscreen, a publication opens in response to a “tap” on its cover. FIG. 3 illustrates an example where the user tapped on publication 30e. In response to the tap, the cover enlarges or “moves toward the user to be in front of the other publications that are not selected,” and rotates as shown by an arrow 40. The rotation may happen about an axis that is parallel to one of the edges of the object image, to simulate the “turning” of a page so it looks like the user is flipping open the cover. When using a computing device or a television, the keyboard, mouse, or remote control may be used to communicate with the display device 20.

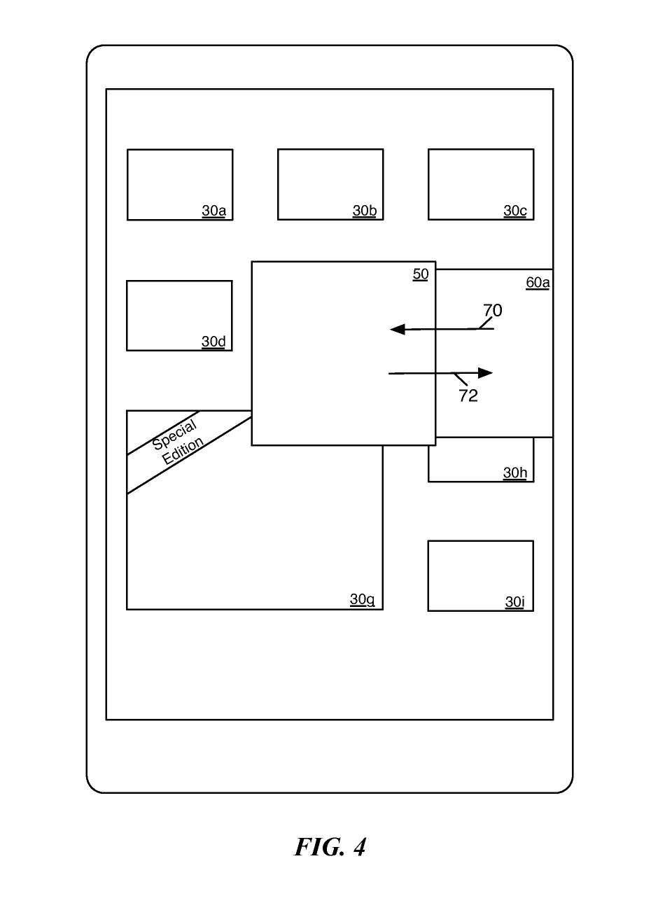

FIG. 4 depicts what is shown after the cover page rotates 180°, or flips open to reveal the “opposite page.” At the end of the rotation, the cover page is replaced by an image of an inside page. An inside page 50, which would correspond to the page that is on the other side of the cover page in a physical publication such as a magazine or a book, is displayed in the space where the cover page was displayed. At the same time, content pages 60a . . . 60x (collectively 60, and x is an arbitrary number) are displayed next to the inside page 50. A user may scroll through the content pages 60, for example with a swiping or sliding motion in a first direction 70 or a second direction 72, the second direction 72 being opposite the first direction 70. In response to the swipe/slide, the content pages 60, which may be arranged in a line, are translated in the first direction or the second direction, allowing the user to view or read the page of his choice.

This disclosure is not limited to any particular type of content in the content pages 60. The content pages may include still photographs, drawings, articles, advertisements, moving images, movies, audio, etc.

Although not explicitly shown, the user can adjust the size of the cover page, the inside page 50, and the content page 60. In a touchscreen embodiment, a simple “tap” or “reverse pinch” can enlarge the page, for example to fit the entire display 10.

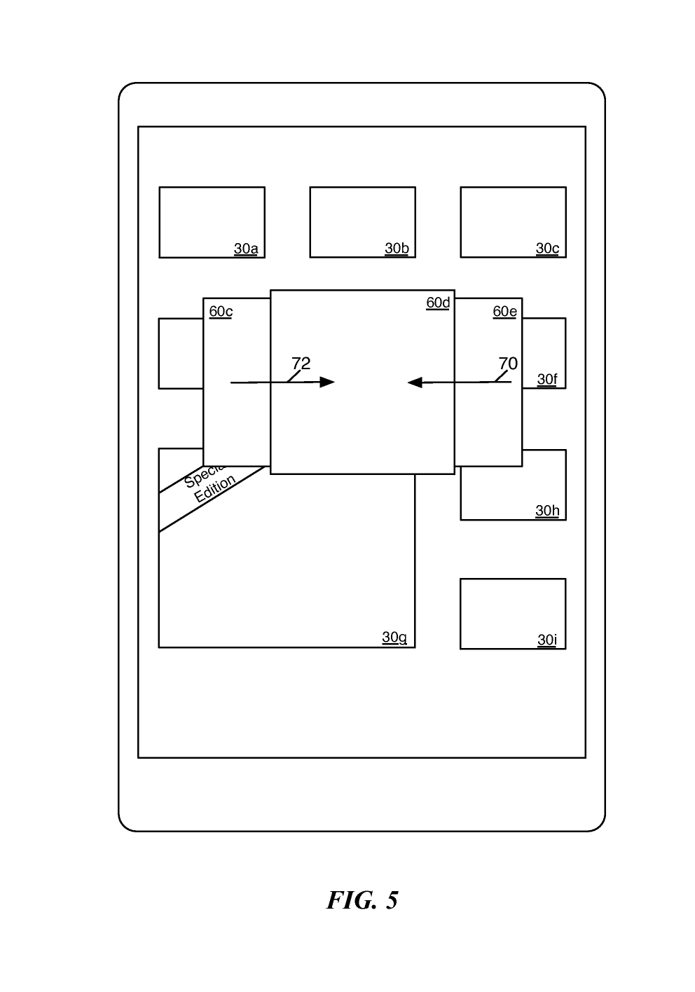

In a typical situation, the user will scroll through the content pages 60 sequentially. While the user may sometimes scroll through all the content pages 60 of the selected publication 30e, he may sometimes have to stop reading before he reaches the last page. FIG. 5 depicts how a user can “close” the publication without reaching the last page. Regardless of which page the user is on when he decides to stop reading, he can collapse and return the selected publication 30e to the magazine rack by simultaneously swiping/sliding his fingers toward each other, in the first direction 70 and the second direction 72. At a touchscreen device, this may be accomplished by simultaneously touching two fingers on the content page(s) 60 and sliding them closer to each other, in a “pinching” motion. In reply to this indication to close the book, the remaining content pages 60 will stack behind, collapse, or slide behind the content page that is closest to the center of the display 10. In the example of FIG. 5, the content pages 60 stack, collapse and/or slide behind the content page 60d such that at the end of the sliding, the user sees just the content page 60d. The content page 60d (and the imaginary stack behind it) then rotates 180° in the manner shown in FIG. 3 to end up being replaced by the cover page. This time, it is as though the cover page and the content page 60d are on two sides of a paper. The cover page then automatically adjusts to the size it should be on the selection page and returns to its original position, back on the “magazine rack.”

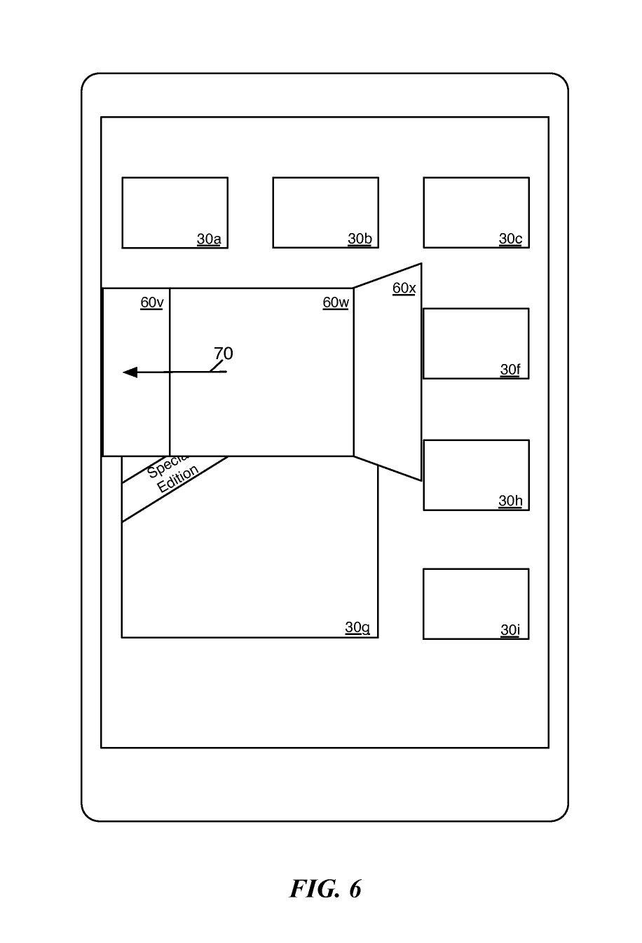

FIG. 6 depicts the situation where the user scrolled through all the content pages 60 of a publication 30e by continually swiping/sliding his finger in the first direction 70. The same swiping/sliding motion that moved the content pages 60 in the first direction 70 automatically closes the publication when applied to the last content page 60x. During this closing, the content pages 60 stack, collapse or hide behind the last content page 60x, which rotates about an axis that is parallel to an edge of the content page 60x, similarly to what is depicted in FIG. 3. At the end of the simulated 180° rotation, a cover page may be shown in place of the last content page, to simulate the cover page and the last content page being on opposite sides of one sheet of paper. The closed publication is then automatically returned to its original position on the selection list.

Although the figures depict the unselected publications in the background of the selected publications as “frozen” and unchanging through all the operations, this is not a limitation of the invention.

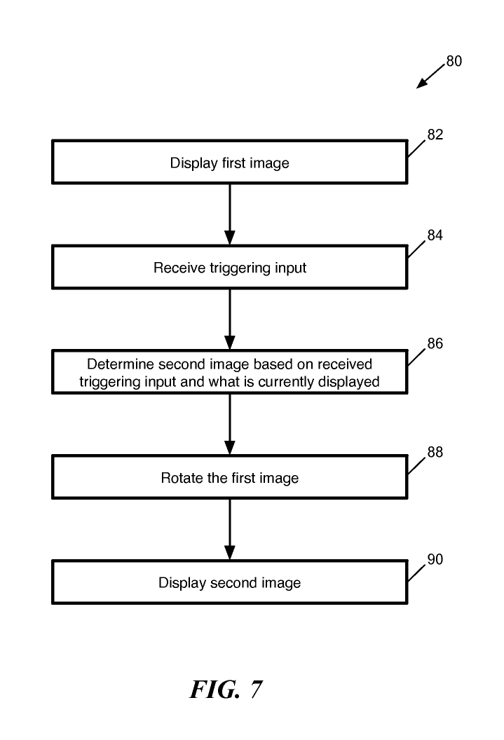

FIG. 7 is a flowchart depicting a method of changing a displayed content in accordance with an embodiment of the inventive concept. The method, herein depicted as a page-turning process 80, entails displaying a first image (step 82), receiving a triggering input (step 84), determining a second image based on the first image and the triggering input (step 86), rotating the first image about an axis that is parallel to an edge of the first image (step 88), and displaying a second image in the space that was occupied by the first image (step 90). As described above, this page-turning process 80 may be triggered in a number of ways. Where a user first selects a publication 30e among a plurality of publications 30, the first image is the cover page, the triggering input is the selection (e.g., a tap), and the second image is the inside page 50. Where the user decides to stop reading the selected publication 30e before reaching the last content page 60x, the first image is the content page that is closest to the center of the display 10 (e.g., the content page 60d in FIG. 5), the triggering input is a bidirectional swipe/slide (e.g., a “pinch”), and the second image is the cover page. Where the user finishes viewing all the content pages 60 of a publication and reaches the last content page 60x, the first image is the last content page 60x, the triggering input is the swipe/slide to continue scrolling even when the last content page 60x has been reached, and the second image is the cover page.

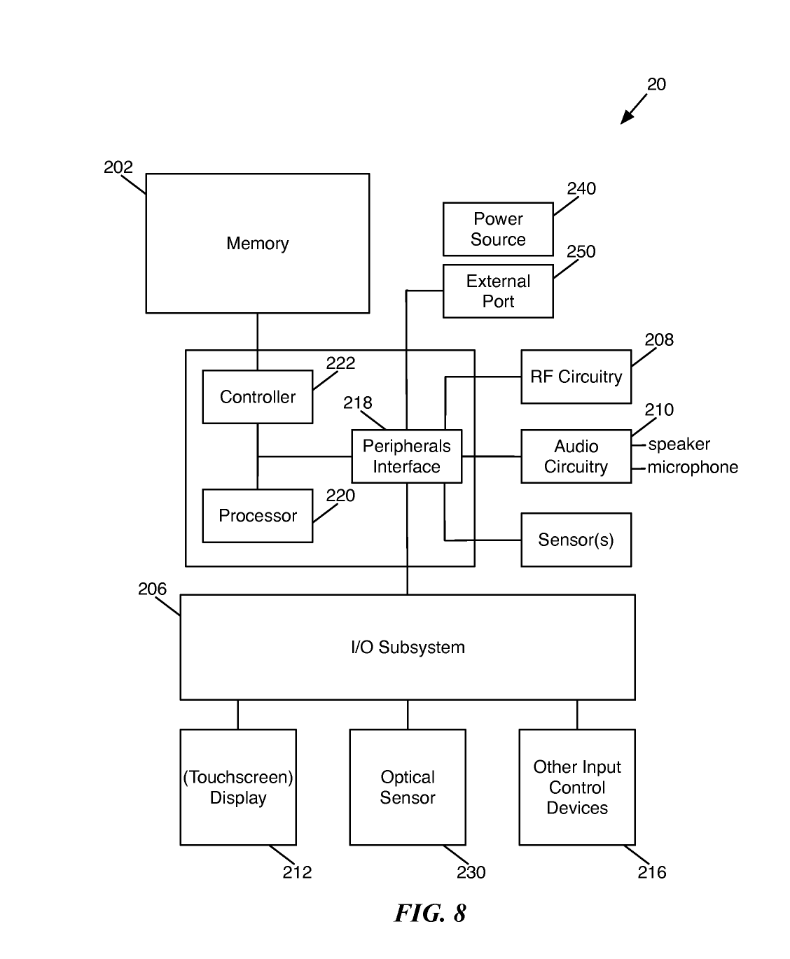

FIG. 8 is a block diagram illustrating an example display device 20 that may be used to implement the inventive concept described above. As shown, the display device 20 may incorporate a touchscreen display 212. The display device 20 includes a memory 202 (which may include one or more computer-readable storage mediums), a memory controller 222, one or more processing units 220, a peripherals interface 218, RF circuitry 208, audio circuitry 210 that control the speaker and microphone, an input/output subsystem 206, other input control devices 216, and optional optical sensor 230. These components may communicate over one or more communication buses or signal lines. The display device 20 also has a power source 240 for powering the components. The power source 240 may include a power management system, one or more power sources (e.g., battery, alternating current), a recharging system, a power failure detection circuit, a power converter or inverter, and a power status indicator, among others. An external port 250 allows the display device 20 to communicate with a network outside the physical boundaries of the device.

Various embodiments of the present invention may be implemented in or involve one or more computer systems. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present invention, the memory may store software for implementing various embodiments of the present invention.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present invention, the storage may store instructions for the software implementing various embodiments of the present invention. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present invention, operating system software may provide an operating environment for software's executing in the computer system, and may coordinate activities of the components of the computer system.

Various embodiments of the present invention may be described in the general context of computer-readable media. Computer-readable media are any available media that may be accessed within a computer system. By way of example, and not limitation, within the computer system, computer-readable media include memory, storage, communication media, and combinations thereof.

Having described and illustrated the principles of the invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While the exemplary embodiments of the present invention are described and illustrated herein, it will be appreciated that they are merely illustrative.

We claim:

1. A method for displaying an electronic publication, the method comprising:
receiving a selection of a cover page displayed for an electronic publication;
animating an opening of the cover page to a first content page of the electronic publication that appears as an opposite side of the cover page during the opening animation;
while displaying a second content page of the electronic publication, receiving input to close the electronic publication; and
animating a closing of the electronic publication in order to display the cover page, wherein the second content page appears as an opposite side of the cover page during the closing animation.

2. The method of claim 1 further comprising displaying the cover page for the electronic publication in a graphical user interface (GUI) that comprises a plurality of cover pages of different electronic publications.

3. The method of claim 1, wherein the cover page comprises at least one of images and text indicating representative content of the electronic publication.

4. The method of claim 1, wherein the selection of the cover page comprises touch input at a location of the cover page on a touchscreen display.

5. The method of claim 1, wherein animating the opening of the cover page comprises enlarging the cover page while rotating the cover page about an axis parallel to an edge of the cover page.

6. The method of claim 1 further comprising, after animating the opening of the cover page and prior to receiving input to close the electronic publication, receiving input to scroll through the electronic publication from the first content page to the second content page.

7. The method of claim 6, wherein the input to scroll through the electronic publication comprises a swipe gestural touch input.

8. The method of claim 6, wherein the second content page is a last content page of the electronic publication, wherein the input to close the electronic publication comprises additional input to scroll through the electronic publication past the last content page.

9. The method of claim 8, wherein animating the closing of the electronic publication comprises:
displaying representations of a plurality of content pages stacking behind the last content page; and
rotating the last content page about an axis parallel to an edge of the last content page in order to display the cover page appearing as an opposite side of the last content page.

10. The method of claim 9, wherein the cover page appears as a front cover in the animation of the opening of the electronic publication and a back cover in the animation of the closing of the electronic publication.

11. The method of claim 6, wherein the second content page is an intermediate content page of the electronic publication, wherein the input to close the electronic publication comprises a different input than the scroll input.

12. The method of claim 11, wherein animating the closing of the electronic publication comprises:
graphically stacking a plurality of content pages behind the second content page; and
rotating the second content page about an axis parallel to an edge of the second content page.

13. The method of claim 11, wherein the input to scroll through the electronic publication comprises a swipe gestural touch input and the input to close the electronic publication comprises a pinch gestural touch input.

14. The method of claim 1 further comprising, after animating the closing of the electronic publication:
receiving a second selection of the cover page; and
animating an opening of the cover page to the second content page that appears as an opposite side of the cover page during the opening animation.

15. A computer-readable medium storing a program which when executed by at least one processing unit displays an electronic publication, the program comprising sets of instructions for:
receiving a selection of a cover page displayed for an electronic publication;
animating an opening of the cover page to a first content page of the electronic publication that appears as an opposite side of the cover page during the opening animation;
while displaying a second content page of the electronic publication, receiving input to close the electronic publication; and
animating a closing of the electronic publication in order to display the cover page, wherein the second content page appears as an opposite side of the cover page during the closing animation.

16. The computer-readable medium of claim 15, wherein the set of instructions for animating the opening of the cover page comprises a set of instructions for enlarging the cover page while rotating the cover page about an axis parallel to an edge of the cover page.

17. The computer-readable medium of claim 15, wherein the program further comprises a set of instructions for, after animating the opening of the cover page and prior to receiving input to close the electronic publication, receiving input to scroll through the electronic publication from the first content page to the second content page.

18. The computer-readable medium of claim 17, wherein the second content page is a last content page of the electronic publication, wherein the input to close the electronic publication comprises additional input to scroll through the electronic publication past the last content page.

19. The computer-readable medium of claim 17, wherein the second content page is an intermediate content page of the electronic publication, wherein the input to close the electronic publication comprises a different input than the scroll input.

20. An electronic device comprising:
a touchscreen display; and
a computer-readable medium storing a program which when executed by at least one processing unit of the electronic device displays an electronic publication on the touchscreen display, the program comprising sets of instructions for:
receiving a selection of a cover page displayed for an electronic publication;
animating an opening of the cover page to a first content page of the electronic publication that appears as an opposite side of the cover page during the opening animation;
while displaying a second content page of the electronic publication, receiving input to close the electronic publication; and
animating a closing of the electronic publication in order to display the cover page, wherein the second content page appears as an opposite side of the cover page during the closing animation.

21. The electronic device of claim 20, wherein the computer program further comprises instructions for, after animating the closing of the electronic publication:
receiving a second selection of the cover page; and
animating an opening of the cover page to the second content page that appears as an opposite side of the cover page during the opening animation.

22. The electronic device of claim 20, wherein the computer program further comprises a set of instructions for displaying the cover page for the electronic publication in a graphical user interface (GUI) that comprises a plurality of cover pages of different electronic publications.
